(19) United States
(12) Patent Application Publication
(10) Pub. No.: US 2025/0296618 A1
(43) Pub. Date: Sep. 25, 2025

(54) LEADSCREW ACTUATOR ASSEMBLY FOR ADJUSTABLE POSITION STEERING WHEEL

(71) Applicant: Steering Solutions IP Holding Corporation, Saginaw, MI (US)

(72) Inventors: Joen C. Bodtker, Gaines, MI (US); Melvin L. Tinnin, Clio, MI (US); Joseph R. Streng, Freeland, MI (US); William S. Anders, Merril, MI (US)

(21) Appl. No.: 18/615,004

(22) Filed: Mar. 25, 2024

(51) Int. Cl. B62D 1/20; B62D 1/185

(52) U.S. Cl. CPC B62D 1/20; B62D 1/185

(57) ABSTRACT

A leadscrew actuator assembly including: a leadscrew configured to rotate about an axis of rotation; a worm gear coupled to the leadscrew to rotate with the leadscrew; a bearing coupled to the leadscrew; and a multi-part housing. The multi-part housing includes: a first portion at least partially defining a first cylindrical cavity for accommodating a rotating spindle of a motor, and the first portion at least partially defines a second cylindrical cavity that extends along the axis of rotation; and a second portion further defining the second cylindrical cavity, the worm gear and the bearing are positioned in the second cylindrical cavity.

### TECHNICAL FIELD

This disclosure generally relates to adjustable steering wheels and, more particularly, to leadscrew actuator assemblies for adjustable steering wheels.

### BACKGROUND

A vehicle, such as a car, truck, sport utility vehicle, crossover, mini-van, marine craft, aircraft, all-terrain vehicle, recreational vehicle, or other suitable vehicles, include various steering system schemes, for example, steer-by-wire and driver interface steering. These steering system schemes typically include a steering column assembly for translating steering input to an output that interacts with a steering linkage to ultimately cause the vehicle wheels to turn. The steering column assembly may telescope to allow a user to adjust the distance between themselves and the steering wheel or rotate about an axis to adjust the height of the wheel. However, these assemblies generally include numerous parts that increase the cost of the entire system.

Accordingly, there is a continuing need to improve the operational framework of steering wheel assemblies to improve upon packaging and reduce cost.

### SUMMARY

According to a first aspect, a leadscrew actuator assembly includes: a leadscrew configured to rotate about an axis of rotation; a worm gear coupled to the leadscrew to rotate with the leadscrew; a bearing coupled to the leadscrew; and a multi-part housing. The multi-part housing includes: a first portion at least partially defining a first cylindrical cavity for accommodating a rotating spindle of a motor, and the first portion at least partially defines a second cylindrical cavity that extends along the axis of rotation; and a second portion further defining the second cylindrical cavity, the worm gear and the bearing are positioned in the second cylindrical cavity.

According to a second aspect, a leadscrew actuator assembly includes: a leadscrew; a worm gear engaged with the leadscrew to rotate with the leadscrew; a multi-part housing including a first portion, a second portion, and an attachment structure the multi-part housing defines a first cylindrical cavity that the worm gear is at least partially positioned in and a second cylindrical cavity that the leadscrew is at least partially positioned in, each of the first portion and the second portion at least partially define the attachment structure, and the attachment structure is configured to be inserted into an opening to couple the first portion and the second portion together.

According to a third aspect, a steering assembly includes: a lower jacket defining an opening; an upper jacket movable relative to the lower jacket; and a leadscrew actuator assembly. The leadscrew actuator assembly includes: a leadscrew configured to rotate about an axis of rotation, the leadscrew defining a threaded portion extending along the axis of rotation and a depression; a worm gear coupled to the leadscrew to rotate with the leadscrew; a housing defining a cylindrical cavity that the worm gear is positioned in, the housing includes an attachment structure configured to be insertable into the opening in the lower jacket and rotated to attach to the lower jacket; and a jackscrew nut defining a threaded opening configured to engage the threaded portion of the leadscrew such that rotation of the leadscrew moves the jackscrew nut relative to the housing.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a vehicle with a steering system, according to one or more embodiments shown and described herein;

FIG. 2 schematically depicts an exploded perspective view of a leadscrew actuator assembly of the steering system of FIG. 1, according to one or more embodiments shown and described herein;

FIG. 3 schematically depicts a partial perspective view of the leadscrew actuator assembly of FIG. 2, according to one or more embodiments shown and described herein;

FIGS. 4A and 4B schematically depict the leadscrew actuator assembly of FIG. 2 being mounted to a jacket of the steering system, according to one or more embodiments shown and described herein;

FIG. 5A schematically depicts an alternative housing for the attachment of the actuator assembly of FIG. 2 to a jacket of the steering system, according to one or more embodiments shown and described herein; and

FIG. 5B schematically depicts another alternative housing for the attachment of the actuator assembly of FIG. 2 to a jacket of the steering system, according to one or more embodiments shown and described herein.

### DETAILED DESCRIPTION

The following discussion is directed to various embodiments of the disclosure. Although one or more of these embodiments may be described in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable vehicles, include various steering system schemes, for example, steer-by-wire and driver interface steering. These steering system schemes typically include a steering column assembly for translating steering input to an output that interacts with a steering linkage to ultimately cause the vehicle wheels to turn. Steering columns include various safety features, such as airbags to lessen impact forces. In addition, many steering column assemblies are collapsible and include one or more energy absorption features, such as energy absorbing straps, that allow a certain amount of compression.

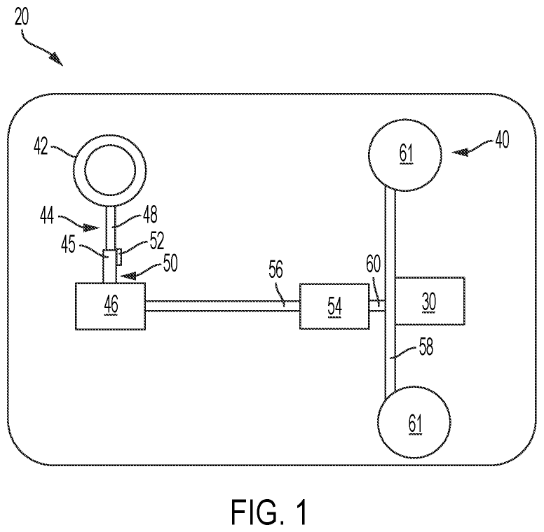

Referring initially to FIG. 1, a vehicle 20 is generally illustrated according to the principles of the present disclosure. The vehicle 20 may include any suitable vehicle, such as a car, a truck, a sport utility vehicle, a mini-van, a crossover, any other passenger vehicle, any suitable commercial vehicle, or any other suitable vehicle. While the vehicle 20 may be a passenger vehicle having wheels and for use on roads, the principles of the present disclosure may apply to other vehicles, such as planes, tractors, boats, or other suitable vehicles. The vehicle 20 may include a propulsion system 30, such as an ignition system, an electronic system, or combinations thereof.

In some embodiments, the vehicle 20 may further include a steering system 40. The steering system 40 may be configured as a driver interface steering system, an autonomous driving system, or a system that allows for both driver interface and autonomous steering. The steering system may include an input device 42, such as a steering wheel, wherein a driver may mechanically provide a steering input by turning the steering wheel. A steering column assembly 44 may include a steering column 45 that extends along an axis from the input device 42 to an output assembly 46. The output assembly 46 may include a pinion shaft assembly, an I-shaft, a cardan joint, steer-by-wire components or any other features conventionally located opposite the input device 42.

The steering column 45 may include at least two axially adjustable portions, for example, a first jacket 48 and a second jacket 50 that are axially adjustable with respect to one another. The first jacket 48 may be an upper jacket and a second jacket 50 may be a lower jacket, wherein the first jacket 48 and the second jacket 50 are permitted to move axially with respect to one another during an impact or other compressive forces. The axial movement may include sliding, telescopic, translating, and other axial movements. The steering column assembly 44 may include additional portions that permit axial movement and brackets that provide rake and tilt movement. The leadscrew actuator assembly disclosed herein may be used for either or both of telescoping and rake/tilt of the steering wheel. In embodiments, where both are performed, the vehicle may include two separate leadscrew actuator assemblies. More particularly, the steering column assembly 44 may include a powered actuator (or actuators) wherein the position adjustments are machine driven. The powered actuator may be in the form of a leadscrew assembly 52 (schematically depicted in FIG. 1) configured to axially adjust the position of the second jacket 50 relative to the first jacket 48.

A steering gear assembly 54 may connect to the output assembly 46 via a steering gear input shaft 56. The steering gear assembly 54 may be configured as a rack-and-pinion, a recirculating ball-type steering gear, or any other types of steering gears associated with autonomous and driver-interface steering systems. The steering gear assembly 54 may then connect to a driving axle 58 via an output shaft 60. The output shaft 60 may include a pitman arm and sector gear or other traditional components. The output shaft 60 is operably connected to the steering gear assembly 54 such that a rotation of the steering gear input shaft 56 causes a responsive movement of the output shaft 60 and causes the drive axle to turn the wheels 61.

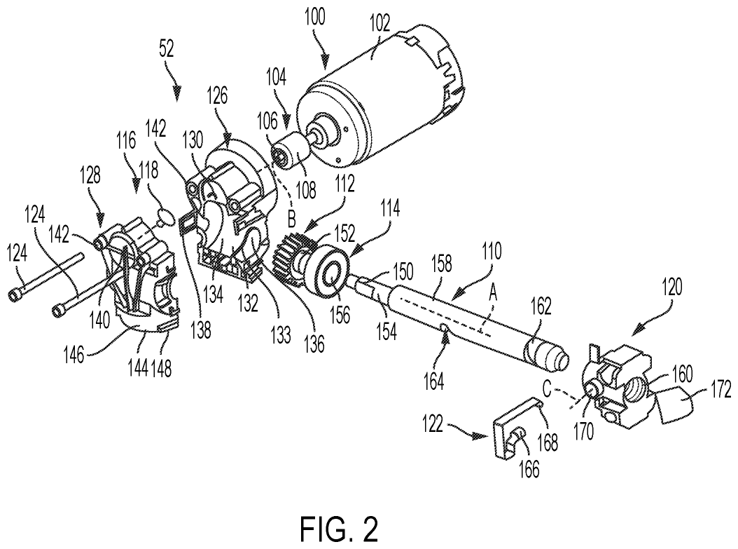

Referring now to FIG. 2, the leadscrew actuator assembly 52 with a motor assembly 100 is depicted. The motor assembly 100 may include a motor housing 102 for housing a motor 104, where the motor 104 includes a rotating spindle 106 with an end piece 108 for transferring motion from the motor 104 to the leadscrew actuator assembly 52. The leadscrew actuator assembly 52 may generally include a leadscrew 110 configured to rotate about an axis of rotation A, a worm gear 112 coupled to the leadscrew 110 to rotate with the leadscrew 110, a bearing 114 coupled to the leadscrew 110, a two-part housing 116 (also referred to herein as a “multi-part housing”, a shaft snubber 118, a jackscrew nut 120, a travel stop 122, and one or more fasteners 124.

While the housing 116 is depicted as having two parts, it is contemplated and possible that the housing 116 has any operable number of parts, such as one, three, or more than three. For exemplary purposes, the depicted housing 116 includes a first portion 126 and a second portion 128 that is attachable to the first portion 126 to define at least one cavity therein to house various components of the leadscrew actuator assembly 52, as will be described in further detail below.

The first portion 126 of the housing 116 may at least partially define a first cylindrical cavity 130 for accommodating the rotating spindle 106 of the motor 104. The first portion 126 may at least partially define a second cylindrical cavity 132 that extends along the axis of rotation A of the leadscrew 110. The second cylindrical cavity 132 may extend along the axis of rotation A to extend oblique or perpendicular to an axis of rotation B of the rotating spindle 106. The first cylindrical cavity 130 may extend along this axis of rotation B of the rotating spindle 106 to allow the rotating spindle 106 to rotate freely within the first cylindrical cavity 130 without contacting the housing 116. The second portion 128 may further define the second cylindrical cavity 132, where the worm gear 112 and the bearing 114 are positioned between the first portion 126 and the second portion 128 in the second cylindrical cavity 132. When positioned in the second cylindrical cavity 132, the worm gear 112 and the bearing 114 are enclosed by the housing 116. The first portion 126, the second portion 128, or both may include a separator wall 133 positioned in the second cylindrical cavity 132 to define, or divide the second cylindrical cavity 132 into, a worm gear receiving portion 134 and a bearing receiving portion 136. In such embodiments, the worm gear 112 is positioned in the worm gear receiving portion 134 and the bearing 114 is positioned in the bearing receiving portion 136. The bearing 114 may be positioned in the bearing receiving portion 136 to be in contact with the first portion 126 and/or the second portion 128 in the second cylindrical cavity 132 such that an outer ring of the bearing 114 does not rotate while an inner ring of the bearing 114 rotates with the leadscrew 110. In this configuration, the leadscrew actuator assembly 52 may include a single bearing 114 for supporting the leadscrew 110, permitting free rotation of the leadscrew 110 while axially retaining the leadscrew 110. The bearing 114 may act to prevent yaw and pitch of the leadscrew 110.

Each of the first portion 126 and the second portion 128 may include snaps 138 that are configured to selectively couple to the snaps 138 on the other of the first portion 126 and the second portion 128. The snaps 138 may be complementary to the other of the first portion 126 and the second portion 128 to allow selective engagement between the snaps. For example, each of the first portion 126 and the second portion 128 may include the same number of snaps, such as 1, 2, 3, more than 3, or the like, where the snaps 138 on the first portion 126 are male snaps 138 and the second portion 128 are female snaps 138 for engaging with the male snaps, or vice versa. The second portion 128 may define an opening 140 opposite the first cylindrical cavity 130 in the first portion 126, where the shaft snubber 118 is positioned within this opening 140 in the second portion 128. The opening 140 and the shaft snubber 118 may be positioned such that the shaft snubber 118 is configured to contact an end of the spindle 106 of the motor 104, thereby preventing contact between the second portion 128 of the housing 116 and the motor 104. In other words, the shaft snubber 118 may act as a resisting spring against the movement of the spindle 106. The shaft snubber 118 may include a shank (not shown) inserted into the opening 140 that is in a press-fit, or friction fit, engagement. The shank may prevent the removal of the shaft snubber 118 from the opening 140. The shaft snubber 118 may be formed of a wear-resistant and low-friction material such that contact between the shaft snubber 118 and the spindle 106 of the motor 104 does not reduce rotational speed of the spindle 106. For example, the shaft snubber 118 may be formed of a hard plastic (methacrylate, polycarbonate, PVC, PETG, ABS, PA (nylon), POM (acetal) or the like), rubber, resin, resilient polymer, or the like.

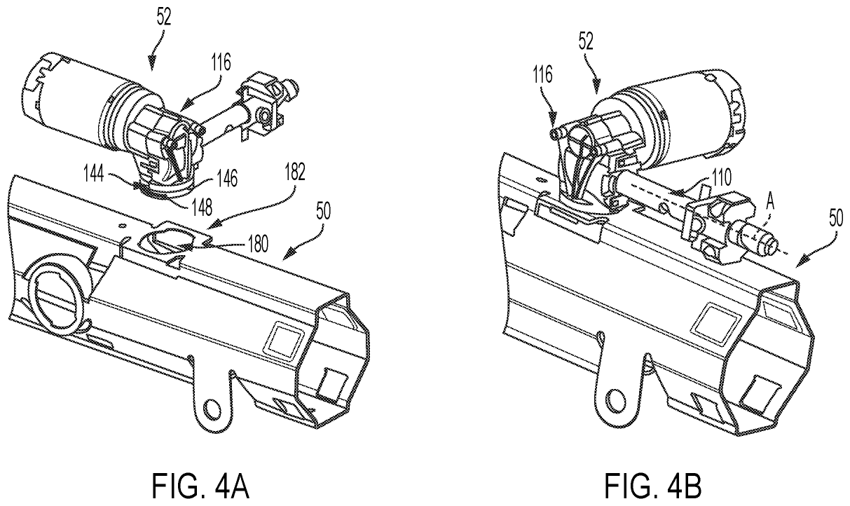

Referring to FIGS. 2 and 4A, the second jacket 50 may define an opening 180 and one or more cutouts 182 extending radially from the opening 180 in the second jacket 50 to permit attachment of the leadscrew actuator assembly 52 to the second jacket 50. The opening 180 and cutouts 182 may be used for coupling with the leadscrew actuator assembly 52 in a twist lock configuration, as will be described in greater detail below. Each of the first portion 126 and the second portion 128 of the housing 116 may define one or more fastener openings 142 for receiving the one or more fasteners 124, where the fasteners 124 may be positioned within the one or more fastener openings 142 in each of the first portion 126 and the second portion 128 to couple the first portion 126 and the second portion 128 together. The fasteners 124 may pass through each of the first portion 126 and the second portion 128 to extend into openings in the motor housing 102, thereby coupling the housing 116 to the motor housing 102. The housing 116 may further include an attachment structure 144 configured to be insertable into the opening in the lower jacket and rotated to attach to the second jacket 50. The attachment structure 144 may be defined by the first portion 126, the second portion 128, or both. The attachment structure 144 may include a pedestal 146 that extends away from the first cylindrical cavity 130 and the second cylindrical cavity 132, and one or more tabs 148 that extend from the pedestal 146. The one or more tabs 148 may be sized and positioned to be insertable into the one or more cutouts 182, where once inserted into the cutouts 182, the housing 116 may be rotated to position the tabs 148 on an underside of the second jacket 50 at the edge of opening 180. The housing 116 may be rotated a number of degrees to move the tabs 148 away from the cutouts 182 such as, for example, 90 degrees. The tabs 148 may be angled from an end of the pedestal 146 toward the housing 116 and the underside of the second jacket 50 to contact the underside of the second jacket 50 and create a press-fit coupling between the housing 116 and the second jacket 50. When the attachment structure 144 is inserted into the opening 180 in the second jacket 50, the opening may contact the pedestal 146 on each of the first portion 126 and the second portion 128 as an additional coupling of the two portions 126, 128 together. In some embodiments, the first portion 126 and the second portion 128 may be coupled together only by the insertion into the opening 180.

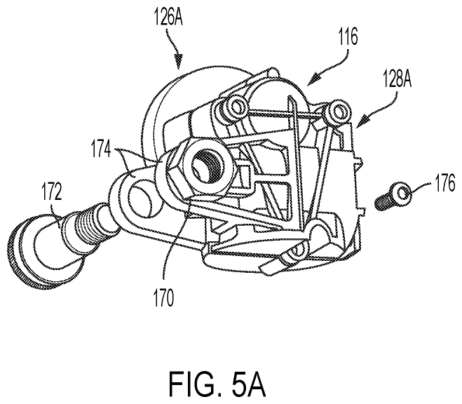

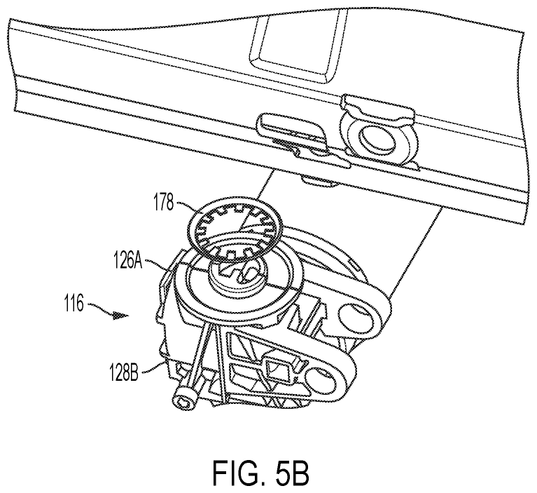

Referring to FIGS. 4A and 4B, the pedestal 146 may extend from the housing 116 to be insertable into the opening 180 in the second jacket 50 such that rotation of the housing 116 engages the tabs 148 with the underside of the second jacket 50. When the leadscrew actuator assembly 52 is attached to the second jacket 50, the leadscrew 110 and the second jacket 50 extend in a same direction to permit movement of the second jacket 50 along the axis of rotation A of the leadscrew 110. Additional attachment structures are contemplated and possible. Specifically, with reference to FIG. 5A, a nut 170, or other similar coupling component, may be attached to the second jacket 50 by welding or the like, where an additional fastener 172 may extend through an eyelet 174 attached to the housing 116 to attach to the nut 170, thereby coupling the housing 116 to the second jacket 50 (FIG. 4B). To prevent expansion of 126 and 128 away from each other, a threaded faster 176 may be used in lieu of opening 180. In some embodiments and with reference to FIG. 5B, a retaining hoop 178 may radially circumscribe the first portion 126 and the second portion 128 at the attachment structure 144 to couple the first portion 126 and the second portion 128 together.

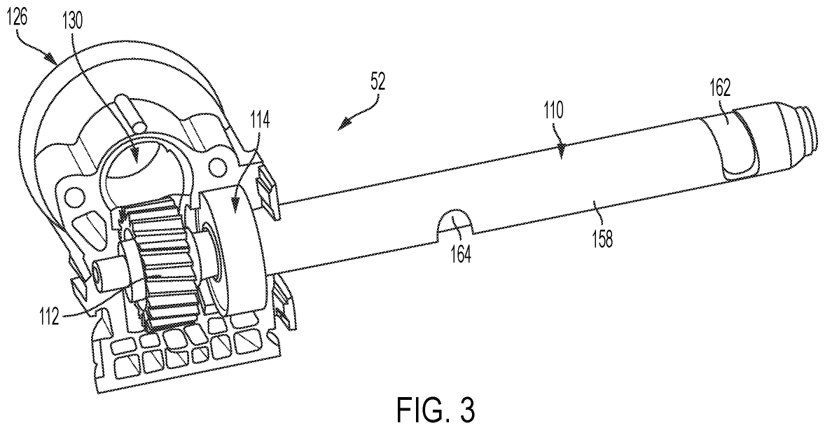

Referring again to FIGS. 2 and 3, the leadscrew 110 may be a traditional leadscrew 110, where threaded engagement between the leadscrew 110 and the jackscrew nut 120 causes movement of the jackscrew nut 120 along the leadscrew 110. For example and as depicted in FIG. 2, the leadscrew 110 includes: (1) a cam portion 150 having a non-cylindrical cross-sectional shape complementary to an opening 152 in the worm gear 112 such that rotation of the worm gear 112 rotates the leadscrew 110; (2) a round portion 154 configured to couple to an opening 156 in the bearing 114; and (3) a threaded portion 158 (schematically depicted in FIGS. 2 and 3) configured to engage a threaded opening 160 in the jackscrew nut 120 such that rotation of the leadscrew 110 moves the jackscrew nut 120 relative to the housing 116. Each of the worm gear 112 and the bearing 114 may include expanded openings to accommodate swage inserts (not shown) that are positioned between the leadscrew 110 and the respective worm gear 112 and bearing 114. The swage inserts increase retention between the leadscrew 110 and the worm gear 112 and bearing 114, thereby preventing disassembly.

In the threaded portion 158 or on opposing sides of the threaded portion 158, the leadscrew 110 may define at least one depression, such as a first depression 162 and a second depression 164, where the second depression 164 is positioned closer to the housing 116 than the first depression 162 is. The first depression 162 and the second depression 164 may define limits to a range of travel of the jackscrew nut 120 relative to the housing 116, as will be described in greater detail below with relation to the travel stop 122. Each of the first depression 162 and the second depression 164 may include a gradually decreasing radius from end to end of the respective depressions. The depressions may at least partially circumferentially surround the leadscrew 110 between the respective ends.

The travel stop 122 may be coupled to at least one of the leadscrew 110 and the jackscrew nut 120, where the travel stop 122 includes a head 166 that is positionable within the depressions in the leadscrew 110 to limit the movement of the jackscrew nut 120 relative to the housing 116. The travel stop 122 may include a clip 168 that attaches to the jackscrew nut 120, where the travel stop 122 biases the head 166 toward the leadscrew 110 to be configured to be positioned within the depressions.

The jackscrew nut 120 may define a threaded opening 160 configured to engage threads on the leadscrew 110 such that rotation of the leadscrew 110 moves the jackscrew nut 120 relative to the housing 116. The threaded opening 160 may extend, or circumferentially surround, the axis of rotation A of the leadscrew 110 such that the jackscrew nut 120 may pass over the leadscrew 110 both toward and away from the housing 116. The jackscrew nut 120 may define a second opening 170 that extends into the threaded opening 160 such that the second opening 170 extends along an axis C that is oblique, transverse, or askew to the axis of rotation A of the leadscrew 110. The clip 168 of the travel stop 122 may be attached to the jackscrew nut 120 such that the head 166 of the travel stop 122 extends into the second opening 170 to be positionable within one of the depressions in the leadscrew 110. This positioning of the travel stop 122 relative to the jackscrew nut 120 allows threads on the leadscrew 110 to be engaged with the threaded opening 160 of the jackscrew nut 120 over the entire range of motion between the two depressions.

The jackscrew nut 120 may be attached to a vehicle structure different to the housing 112 such that rotation of the leadscrew 110 moves the second jacket 50 relative to the other vehicle structure, thereby moving the steering wheel toward and away from the driver. This movement of respective structures causes the housing 116 to move relative to the vehicle structure, thereby adjusting the position of the second jacket 50 and the steering wheel with respect to the driver.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A leadscrew actuator assembly comprising:
a leadscrew configured to rotate about an axis of rotation;
a worm gear coupled to the leadscrew to rotate with the leadscrew;
a bearing coupled to the leadscrew; and
a multi-part housing comprising:
a first portion at least partially defining a first cylindrical cavity for accommodating a rotating spindle of a motor, and the first portion partially defining a second cylindrical cavity that extends along the axis of rotation of the leadscrew; and
a second portion further defining the second cylindrical cavity, the worm gear and the bearing positioned in the second cylindrical cavity.

2. The leadscrew actuator assembly of claim 1, wherein at least one of the first portion and the second portion comprises a separator wall positioned in the second cylindrical cavity to define a worm gear receiving portion and a bearing receiving portion, the worm gear is positioned in the worm gear receiving portion, and the bearing is positioned in the bearing receiving portion.

3. The leadscrew actuator assembly of claim 1, wherein each of the first portion and the second portion comprise at least one snap configured to selectively couple to the snap(s) on the other of the first portion and the second portion.

4. The leadscrew actuator assembly of claim 1, further comprising a shaft snubber positioned within the second portion, the shaft snubber configured to contact an end of the rotating spindle of the motor.

5. The leadscrew actuator assembly of claim 1, further comprising a jackscrew nut defining a threaded opening configured to engage the leadscrew, wherein the leadscrew comprises:
a cam portion having a non-cylindrical cross-sectional shape complementary to an opening in the worm gear such that rotation of the worm gear rotates the leadscrew;
a round portion configured to couple to an opening in the bearing; and
a threaded portion configured to engage the threaded opening in the jackscrew nut such that rotation of the leadscrew moves the jackscrew nut relative to the multi-part housing.

6. The leadscrew actuator assembly of claim 1, further comprising one or more fasteners, wherein each of the first portion and the second portion of the housing define one or more openings, and the one or more fasteners are positioned within the one or more openings in each of the first portion and the second portion to couple the first portion and the second portion together.

7. The leadscrew actuator assembly of claim 5, further comprising a travel stop coupled to at least one of the leadscrew and the jackscrew nut, the travel stop comprises a head, wherein the leadscrew defines at least one depression and the head of the travel stop is configured to be positionable within the at least one depression in the leadscrew to limit the movement of the jackscrew nut relative to the housing.

8. The leadscrew actuator assembly of claim 5, wherein the at least one depression comprises a first depression and a second depression positioned closer to the housing than the other depression, and the first depression and the second depression define limits to a range of travel of the jackscrew nut relative to the housing.

9. A leadscrew actuator assembly comprising:
a leadscrew;
a worm gear engaged with the leadscrew to rotate with the leadscrew;
a multi-part housing comprising a first portion, a second portion, and an attachment structure the multi-part housing defines a first cylindrical cavity that the worm gear is at least partially positioned in and a second cylindrical cavity that the leadscrew is at least partially positioned in, each of the first portion and the second portion at least partially define the attachment structure, and the attachment structure is configured to be inserted into an opening to couple the first portion and the second portion together.

10. The leadscrew actuator assembly of claim 9, further comprising a jacket defining the opening that couples the first portion and the second portion of the housing together when the attachment structure is inserted into the opening.

11. The leadscrew actuator assembly of claim 10, wherein the attachment structure comprises a pedestal and at least one tab extending from the pedestal.

12. The actuator assembly of claim 11, wherein the attachment structure comprises a pedestal and at least one tab extending from the pedestal, and the jacket further defines at least one cutout sized and shaped to allow the tab to extend therethrough when the pedestal is inserted into the opening.

13. The actuator assembly of claim 12, wherein the housing and the jacket are coupled together by insertion of the attachment structure into the opening and rotation of the housing relative to the jacket.

14. The actuator assembly of claim 9, wherein the first portion and the second portion of the housing each at least partially define the second cylindrical cavity.

15. A steering assembly comprising:
a lower jacket defining an opening;
an upper jacket movable relative to the lower jacket;
a leadscrew actuator assembly comprising:
a leadscrew configured to rotate about an axis of rotation, the leadscrew defining a threaded portion extending along the axis of rotation and a depression;
a worm gear coupled to the leadscrew to rotate with the leadscrew;
a housing defining a cylindrical cavity that the worm gear is positioned in, the housing comprises an attachment structure configured to be insertable into the opening in the lower jacket and rotated to attach to the lower jacket; and
a jackscrew nut defining a threaded opening configured to engage the threaded portion of the leadscrew such that rotation of the leadscrew moves the jackscrew nut relative to the housing.

16. The steering assembly of claim 15, wherein the jackscrew nut is configured to be attached to a vehicle structure such that rotation of the leadscrew moves the lower jacket relative to the vehicle structure.

17. The steering assembly of claim 15, wherein the attachment structure comprises one or more tabs, and the lower jacket further defines one or more cutouts extending radially from the opening in the lower jacket, the one or more tabs are sized and positioned to be insertable into the one or more cutouts.

18. The steering assembly of claim 17, wherein the attachment structure further comprises a pedestal that the one or more tabs extend from, the pedestal extends from the housing to be insertable into the opening in the lower jacket such that rotation of the housing engages the tabs with an underside of the lower jacket.

19. The steering assembly of claim 15, wherein when the leadscrew actuator assembly is attached to the lower jacket, the leadscrew and the lower jacket extend in a same direction to permit movement of the lower jacket along the axis of rotation of the leadscrew.

20. The steering assembly of claim 15, wherein the housing is a multi-part structure comprising:
a first portion at least partially defining the cylindrical cavity; and
a second portion further defining the cylindrical cavity, wherein each of the first portion and the second portion define the attachment structure.
